(19) United States
(12) Patent Application Publication
(10) Pub. No.: US 2013/0271326 A1
(43) Pub. Date: Oct. 17, 2013

(54) ELECTRONIC APPARATUS AND CONVERSION ADAPTOR

(71) Applicant: KABUSHIKI KAISHA TOSHIBA, Tokyo (JP)

(72) Inventor: Hiroshi Shimasaki, Kunitachi-shi (JP)

(73) Assignee: KABUSHIKI KAISHA TOSHIBA, Tokyo (JP)

(21) Appl. No.: 13/766,415

(22) Filed: Feb. 13, 2013

(30) Foreign Application Priority Data
Apr. 13, 2012 (JP) 2012-092372

(51) Int. Cl. H01Q 9/04

(52) U.S. Cl. CPC H01Q 9/045; H01Q 9/0421
USPC 343/700 MS

(57) ABSTRACT

According to one embodiment, an electronic apparatus comprises a attachment for removably inserted a attachable device includes a coupler configured to transmit and receive electromagnetic waves. The attachable device comprises a union element, and a power supplying element provided on a first surface and connecting the union element to a feeding point. The electronic apparatus comprises a non-union element. At least part of the non-union element or at least part of a conductive member projecting from the non-union element faces the power supplying element and is spaced apart from the power supplying element when the attachable device is inserted in the attachment.

### CROSS-REFERENCE TO RELATED APPLICATIONS

This application is based upon and claims the benefit of priority from Japanese Patent Application No. 2012-092372, filed Apr. 13, 2012, the entire contents of which are incorporated herein by reference.

### FIELD

Embodiments described herein relate generally to an electronic apparatus and a conversion adaptor, both for use in the case where a coupler to transmit and receive electromagnetic waves has a limited area.

### BACKGROUND

In recent years, near field communication technology has been developed. The near field communication technology enables two devices spaced by a short distance to communicate with each other. Each of such devices having the function of near field communication includes a coupler. When two devices exist in a communication area, their couplers are electromagnetically coupled to each other. Once the couplers have been so coupled, the devices can transmit and receive signals by radio.

A coupler of a representative type comprises, for example, a coupling element, an electrode pole, a resonance stub and a ground. The resonance stub functions as a resonance unit. The resonance stub is a conductor pattern formed on a printed circuit board. A signal is supplied to the coupling element through the resonance stub and the electrode pole. As a result, a current flows in the coupling element, generating an electromagnetic field around the coupler. The electromagnetic field enables the couplers incorporated in two devices close to each other to undergo electromagnetic coupling.

The coupler may be provided in a limited area in some cases. For example, the coupler is provided in a micro SD card that may be inserted in electronic apparatuses having no couplers, or in a limited mounting area available in an electronic apparatus. Any coupler provided in a limited area is inevitably small and may reduce the communication performance at desirable frequencies.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing an exemplary configuration of an electronic apparatus and a card device, both according to an embodiment.

FIG. 2 is an exemplary perspective view showing the configuration of the coupler incorporated in the card device shown in FIG. 1.

FIG. 3 is an exemplary diagram showing an exemplary configuration of the coupler assisting element provided in the electronic apparatus according to the embodiment.

FIG. 4 is an exemplary perspective view showing a positional relation the coupler and the coupler assisting element have while the card device remains inserted in the card slot of the electronic apparatus.

FIG. 5 is an exemplary side view of the coupler and coupler assisting element, as viewed in the direction of arrow A shown in FIG. 4.

FIG. 6 is an exemplary sectional view of the coupler and coupler assisting element, taken along line B-B′ shown in FIG. 4.

FIG. 7A and FIG. 7B are exemplary diagrams explaining the parameters applied in a characteristic simulation.

FIG. 8A, FIG. 8B and FIG. 8C are exemplary diagrams, respectively showing the S21 characteristic, radiation characteristic and return-loss characteristic (S11) of the coupler and coupler assisting element.

FIG. 9A, FIG. 9B and FIG. 9C are exemplary diagrams showing, respectively the total surface current distribution (i.e., surface currents of the coupler and coupler assisting element), the surface current distribution of the coupler, and the surface current distribution of the coupler assisting element.

FIG. 10 is an exemplary diagram showing an exemplary element-arrangement of the coupler and an exemplary element-arrangement of the coupler assisting element.

FIG. 11 is an exemplary diagram showing another exemplary element-arrangement of the coupler and an exemplary element-arrangement of the coupler assisting element.

FIG. 12 is an exemplary diagram showing still another exemplary element-arrangement of the coupler and an exemplary element-arrangement of the coupler assisting element.

FIG. 13 is an exemplary diagram showing a different exemplary element-arrangement of the coupler and an exemplary element-arrangement of the coupler assisting element.

FIG. 14 is an exemplary diagram showing another exemplary element-arrangement of the coupler and an exemplary element-arrangement of the coupler assisting element.

FIG. 15 is an exemplary diagram showing still another exemplary element-arrangement of the coupler and an exemplary element-arrangement of the coupler assisting element.

FIG. 16 is an exemplary perspective view showing an exemplary configuration of the coupler according to the embodiment.

FIG. 17 is a sectional view of the coupler, taken along line C-C′ shown in FIG. 16.

FIG. 18 is an exemplary perspective view showing the coupler assisting element provided in an electronic apparatus with a card slot in which a card device having the coupler of FIG. 16 is inserted.

FIG. 19 is an exemplary perspective view showing a coupler and a coupler assisting element, the coupler being provided in the card device inserted in the card slot of an electronic apparatus.

FIG. 20 is an exemplary sectional view of the coupler and coupler assisting element, taken along line D-D′ shown in FIG. 19.

FIG. 21 is an exemplary perspective view showing an electronic apparatus having a card slot into which a card device may be inserted.

FIG. 22 is an exemplary magnified perspective view showing the card slot into which a card device may be inserted.

FIG. 23 is an exemplary perspective, view showing a slate PC holding the card device.

FIG. 24 is an exemplary block diagram showing the system configuration of a computer and card device.

FIG. 25 is an exemplary perspective view showing a conversion adaptor configured to insert a micro SD card into an SD card slot.

FIG. 26 is an exemplary perspective view showing the micro SD card inserted in the conversion adaptor.

FIG. 27 is an exemplary plan view showing a positional relation the coupler and coupler assisting element have while the card device remains inserted in the card slot of the electronic apparatus.

FIG. 28 is an exemplary sectional view showing the coupler and the coupler assisting element, both inserted in the card slot of the electronic apparatus taken along E-E′ line in FIG. 27.

### DETAILED DESCRIPTION

Various embodiments will be described hereinafter with reference to the accompanying drawings.

In general, according to one embodiment, an electronic apparatus comprises a attachment for removably inserted a attachable device configured to transmit and receive electromagnetic waves. The attachable device comprises a union element, and a power supplying element provided on a first surface and connecting the union element to a feeding point. The electronic apparatus comprises a non-union element. At least part of the non-union element or at least part of a conductive member projecting from the non-union element faces the power supplying element and is spaced apart from the power supplying element when the attachable device is inserted in the attachment.

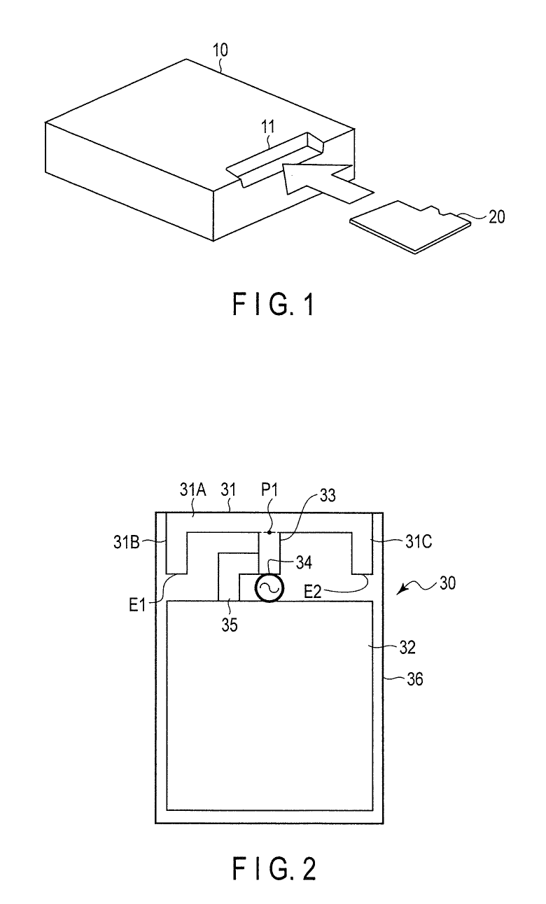

FIG. 1 is a diagram showing the outer appearance of an electronic apparatus and a card device. The electronic apparatus is, for example, a notebook-type personal computer, a tablet personal computer or a digital camera.

As shown in FIG. 1, the electronic apparatus 10 has a card slot 11. The card device 20 can be removably inserted into the card slot 11. The card device 20 is, for example, a micro SD card (trademark).

With reference to FIG. 2, the coupler 30 incorporated in the card device will be described. The coupler 30 is configured to transmit and receive electromagnetic waves to and from any other coupler by means of electromagnetic coupling therewith. The coupler 30 is a device for use in near field communication. The near field communication accomplishes data transfer between devices located at short distances. The near field communication is, for example, TransferJet (trademark). TransferJet is a near field communication system that utilizes the ultra wide band (UWB). If two devices approach each other (for example, located at distance of 3 cm from each other), the couples incorporated in them will be coupled electromagnetically. Then, the devices can transmit and receive signals to and from each other.

As shown in FIG. 2, the coupler 30 includes a coupling element 31, a ground plane 32, a power supplying element 33, a feeding point 34, and a short-circuiting element 35. The coupling element 31, ground plane 32, power supplying element 33 and feeding point 34 are made of a conductive material. The coupling element 31, ground plane 32 and power supplying element 33 are shaped like a flat plate. The coupling element 31, ground plane 32, power supplying element 33 and short-circuiting element 35 are provided on a substrate (first surface) 36.

The coupling element 31 is used to achieve electromagnetic coupling between the coupler 30 and any other coupler. The coupling element 31 comprises elements 31A, 31B and 31C. The element 31A is connected at one end to one end of the element 31B. The other end of element 31B is a first open end E1. The other end of the element 31A is connected to one end of the element 31C. The other end of the element 31C is a second open end E2. The element 31A is arranged, extending in its lengthwise direction and in parallel to the ground plane 32.

The power supplying element 33 connects the feeding point 34 to the coupling element 31. The power supplying element 33 is connected, at one end, to the middle part A1 of the element 31A. The other end of the power supplying element 33 is connected to the feeding point 34.

The electrical length measured from the feeding point 34 to the distal end of the element 31B, and the electrical length measured from the feeding point 34 to the distal end of the element 31C are about a quarter (¼) of the wavelength X associated with the center frequency of the electromagnetic wave the coupler 30 receives. That is, the distance from the feeding point 34 to the open end of the element 31B, over the power supplying element 33, element 31A and element 31B, and the distance from the feeding point 34 to the open end of the element 31C, over the power supplying element 33, element 31A and element 31C are about quarter (¼) of the wavelength X associated with the center frequency of the electromagnetic wave transmitted and received.

As shown in FIG. 2, the short-circuiting element 35 connects (or short-circuits) the coupling element 31 and the ground plane 32 to increase the impedance (input impedance) of the coupler 30. In this embodiment, the short-circuiting element 35 does not directly connect the coupling element 31 to the ground plane 32, but connects the power supplying element 33 to the ground plane 32. More specifically, one end of the short-circuiting element 35 is arranged (connected) between one end of the power supplying element 33, and the other end of the short-circuiting element 35 is connected to the ground plane 32.

In TransferJet, the center frequency is 4.48 GHz, and the band is 560 MHz. If the coupler is incorporated into a micro SD card, the band may become narrower or the characteristics of the coupler 30 may be degraded.

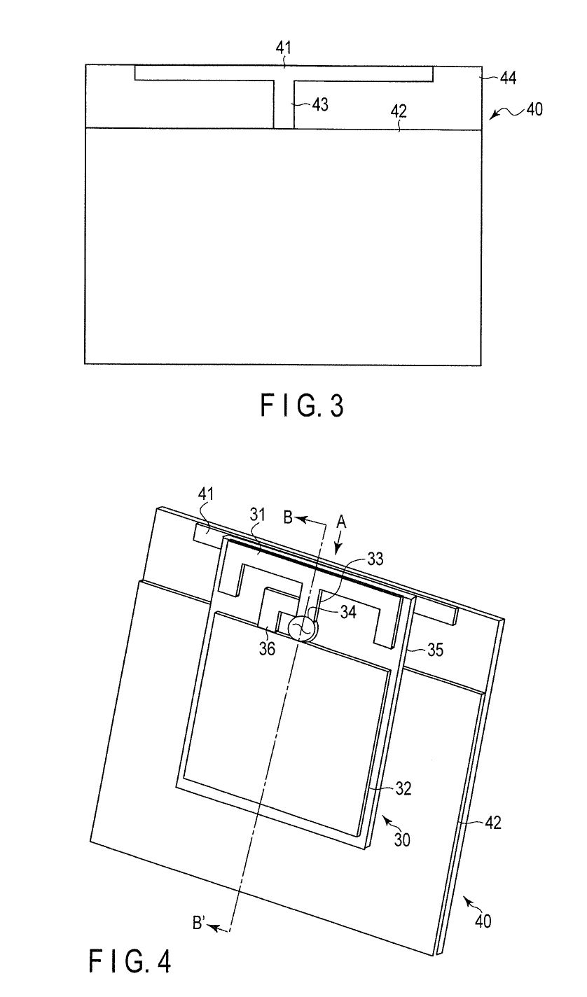

The electronic apparatus 10 has a coupler assisting element configured to suppress the characteristic degradation of the coupler 30. FIG. 3 is a diagram showing the configuration of the coupler assisting element 40.

As shown in FIG. 3, the coupler assisting element 40 includes a conductive element 41, a ground plane 42 and a connecting element 43. The conductive element 41, ground plane 42 and connecting element 43 are made of a conductive material. The conductive element 41 and the connecting element 43 are non-coupling elements, i.e., elements not supplied with power at all. The conductive element 41, ground plane 42 and connecting element 43 are formed on a substrate (second surface) 44. The connecting element 43 is a conductive element projecting from the middle part of the conductive element 41, as seen in the lengthwise direction thereof, for example at right angles to the lengthwise direction. The conductive element 41 and the ground plane 42 are electrically connected by the connecting element 43. The conductive element 41, ground plane 42 and connecting element 43 are shaped like a flat plate. The substrate (second surface) 44 is spaced apart from, and opposed to, the substrate (first surface) 36.

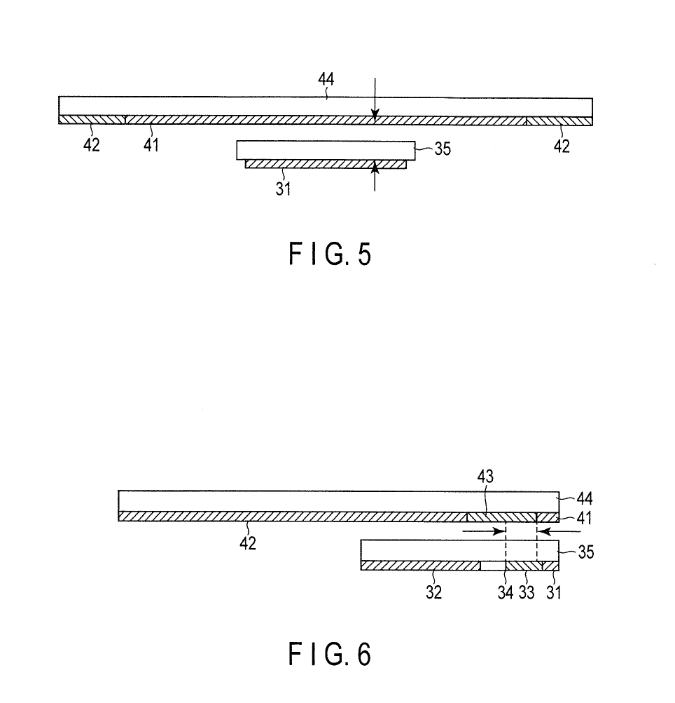

FIG. 4 to FIG. 6 are diagrams showing the positional relation the card device 20 has with the coupler 30 while it remains inserted (or loaded) in the card slot 11. More precisely, FIG. 4 is a perspective view showing a positional relation between the coupler 30 and the coupler assisting element 40. FIG. 5 is a side view of the coupler 30 and the coupler assisting element 40, as viewed in the direction of arrow A shown in FIG. 4. FIG. 6 is a sectional view of the coupler 30 and the coupler assisting element 40, taken along line B-B′ shown in FIG. 4.

As shown in FIG. 5 and FIG. 6, the substrate (first surface) 36 and the substrate (second surface) 44 overlap one another in the direction perpendicular to their surfaces. That is, the substrate (second surface) 44 is spaced apart from, and opposed to, the substrate (first surface) 36. The conductive element 41 of the coupler assisting element 40 overlaps (faces) the coupling element 31 of the coupler 30, and is located close to the coupling element 31. The conductive element 41 of the coupler assisting element 40 and the coupling element 31 of the coupler 30 overlap (face) each other, in the direction perpendicular to the substrate (second surface) 44. That is, the conductive element 41 is arranged, spaced apart from, and opposed to, the coupler 30.

As shown in FIG. 6, the connecting element 43 of the coupler assisting element 40 overlaps the power supplying element 33 of the coupler 30, and the connecting element 43 and the power supplying element 33 are located close to each other. The connecting element 43 of the coupler assisting element 40 and the power supplying element 33 of the coupler 30 overlap each other, in the direction perpendicular to the substrate 44. As shown in FIG. 6, too, a part of the conductive element 41 of the coupler assisting element 40 overlaps (faces) the power supplying element 33 of the coupler 30.

In FIG. 6, the ground plane 42 is positioned, with its end close to the conductive element 41, located father from the conductive element 41 and coupling element 31 than that end of the ground plane 32, which contacts the coupling element 31. The positional relation between these ends is not limited to this. Nonetheless, if the distance between the coupling element 31 and the ground plane 42 is longer than the distance between the coupling element 31 and the ground plane 32, the communication characteristics may be improved. If the distance between the conductive element 41 and the ground plane 42 is longer than the distance between the coupling element 31 and the ground plane 32, the communication characteristics may also be improved.

If a current flows from the feeding point 34 to the power supplying element 33, a current will flow in the connecting element 43 of the coupler assisting element 40, which is adjacent to the power supplying element 33, by virtue of electromagnetic induction. If a current flows from the power supplying element 33 to the coupling element 31, a current will flow in the conductive element 41 of the coupler assisting element 40, which is adjacent to the coupling element 31, also by virtue of electromagnetic induction. Since the conductive element 41 is longer than the coupling element 31, the electromagnetic wave radiated when the coupler 30 is used together with the coupler assisting element 40 has a lower frequency than it has when the coupler assisting element 40 is not used. As a result, either the radiation characteristic or S21 characteristic make better performance at the desirable frequency used for communication. Therefore, not only can the coupler 30 be made small, but also the resonance frequency can be lowered. The conductive element 41 may indeed have a smaller area than the coupling element 31. However, if the conductive element 41 is at least longer than the coupling element 31 in a lengthwise direction, the communication characteristics improve.

If data is transferred from any other coupler, a current will flow from this coupler to the conductive element 41 by virtue of electromagnetic induction. As the current flows in the conductive element 41, a current flows in the coupling element 31 adjacent to the conductive element 41, because of electromagnetic induction. Further, as the current flows from the conductive element 41 to the connecting element 43, a current flows in the power supplying element 33 that exists close to the power supplying element 33, by virtue of electromagnetic induction.

Note that the electrical length measured from the feeding point 34 to the distal end of the conductive element 41 is about a quarter (¼) of the wavelength λ associated with the center frequency of the electromagnetic wave (high-frequency signal) transmitted and received if both the coupler 30 and the coupler assisting element 40 are utilized.

The case where the coupler assisting element 40 has a connecting element 43 and a ground plane 42 has been explained with reference to FIG. 3 to FIG. 6. Nonetheless, the coupler assisting element 40 need not have both the connecting element 43 and the ground plane 42. More precisely, the coupler assisting element 40 may not have the ground plane 42, or may be composed of the conductive element 41, connecting element 43 and substrate 44. In this case, the conductive element 41 or the connecting element 43, or both, overlap at least a part of the power supplying element 33 of the coupler 30 while the card device 20 remains inserted in the card slot 11. If the ground plane 42 is not used, the connecting element 43 is not a member for connecting the conductive element 41 and the ground plane 42, but is a member projecting from the conductive element 41. In view of this, the connecting element 43 can be called a “projecting element.”

Moreover, the coupler assisting element 40 may not have the ground plane 42 or the connecting element 43, or may be composed of only the conductive element 41 and the substrate 44. In this case, the conductive element 41 overlaps (faces) at least a part of the power supplying element 33 of the coupler 30 while the card device 20 remains inserted in the card slot 11.

The ground plane 32 of the coupler 30 and the ground plane 42 of the coupler assisting element 40 are electrically connected. The characteristic degradation of the coupler 30 can therefore be suppressed.

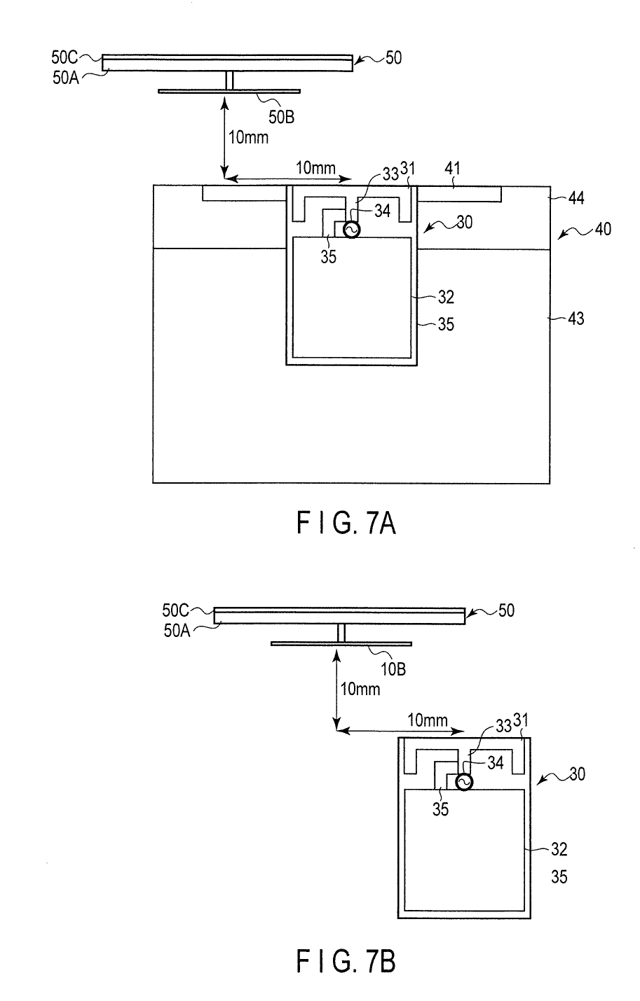

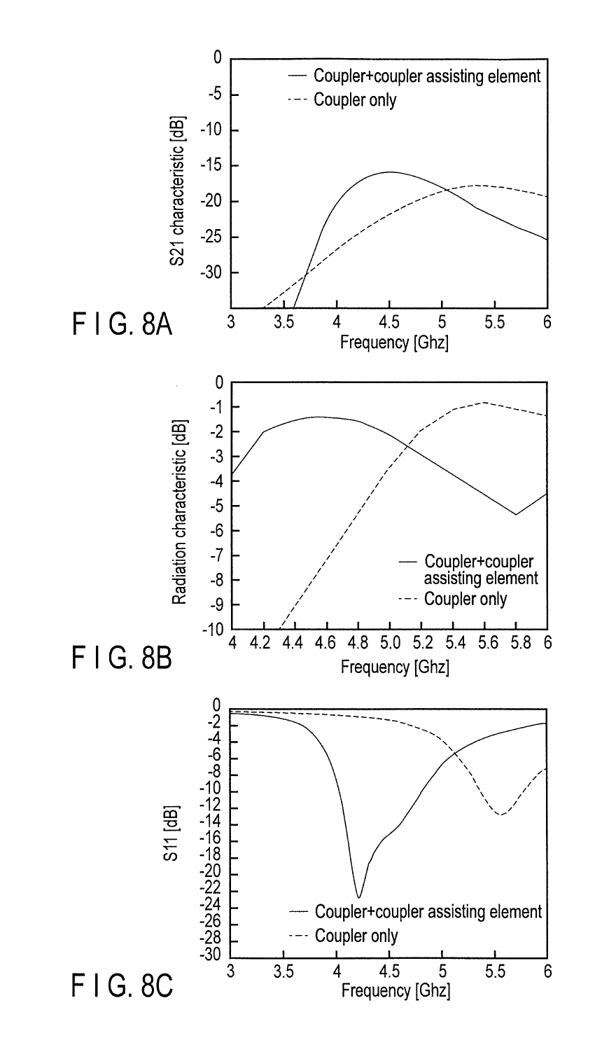

The result of a characteristic simulation performed in a case where the coupler 30 and the coupler assisting element 40 overlap each other will be explained with reference to FIG. 7A and FIG. 7B, FIGS. 8A, 8B and 8C, FIGS. 9A and 9B, FIG. 10, FIG. 11, FIG. 12 and FIG. 13. FIG. 7A is a diagram showing the conditions for simulating the communication characteristics that the coupler 30 and a reference coupler 50 have if the coupler 30 and the coupler assisting element 40 overlap each other. The reference coupler 50 may be of the type well known in this technical field. As shown in FIG. 7A and FIG. 7B, the reference coupler 50 comprises a substrate 50A, a coupling element 50B and a ground plane 50C.

FIG. 7B is a diagram showing the conditions for simulating the communication characteristics of the coupler 30 and reference coupler 50. FIG. 8A shows the S21 characteristic observed under the simulation conditions of FIGS. 7A and 7B. In FIG. 8A, the frequency and transmission coefficient (S21 [db]) are plotted on the horizontal axis and the vertical axis, respectively. Similarly, FIG. 8B shows the radiation efficiency under the simulation conditions of FIGS. 7A and 7B, and FIG. 8C shows the return-loss characteristic (S11 [dB]) under the simulation conditions of FIGS. 7A and 7B. The simulation conditions are as follows.

As shown in FIGS. 7A and 7B, the coupling element 50B of the reference coupler 50 is shifted by 10 mm to the left with respect to the coupling element 31 of the coupler 30, and the offset distance between the coupler 30 and the reference coupler 50 is set to 10 mm in the vertical direction.

As seen from FIG. 8A showing the S21 characteristic and FIG. 8B showing the radiation efficiency, the characteristics are improved for the desired band (i.e., 4.2 to 4.8 GHz). Further, as seen from FIG. 8C showing the return-loss characteristic, the peak frequency observed if the coupler 30 and the coupler assisting element 40 are combined can be lower than in the case where only the coupler 30 is used.

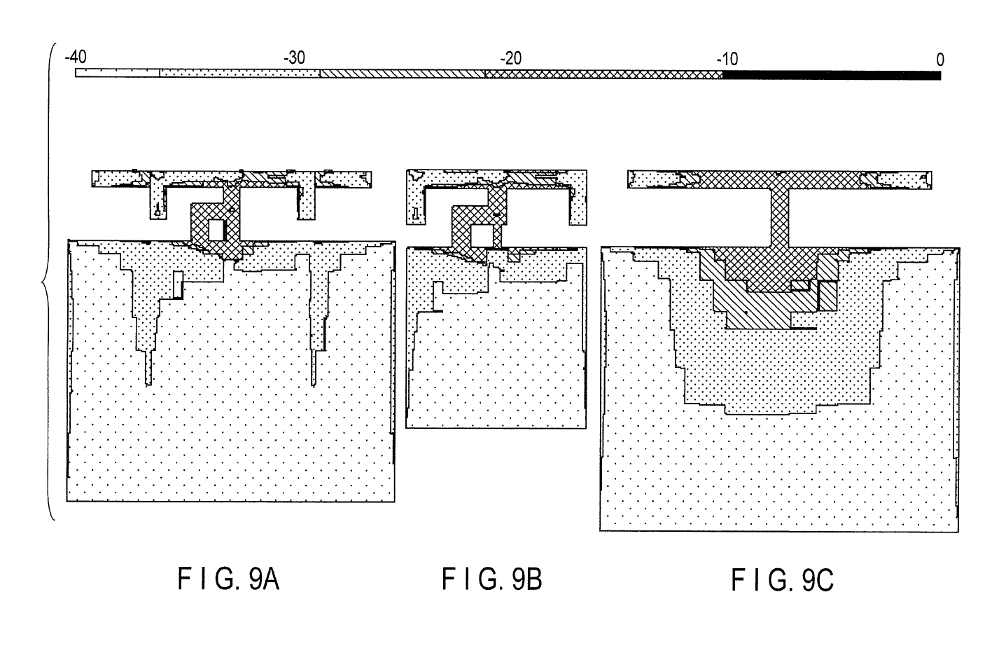

FIGS. 9A, 9B and 9C show the result of analyzing the current (i.e., surface current) distribution of the coupler. More precisely, FIG. 9A shows the result of analyzing the surface current that is the sum of the surface current of the coupler 30 and that of the coupler assisting element 40, FIG. 9B shows the distribution of the surface current of the coupler 30, and FIG. 9C shows the distribution of the surface current of the coupler assisting element 40. In FIGS. 9A, 9B and 9C, the higher the current flow, the darker the area in which it flows. As is understood from FIGS. 9A, 9B and 9C, a large current flows also in the non-coupling elements.

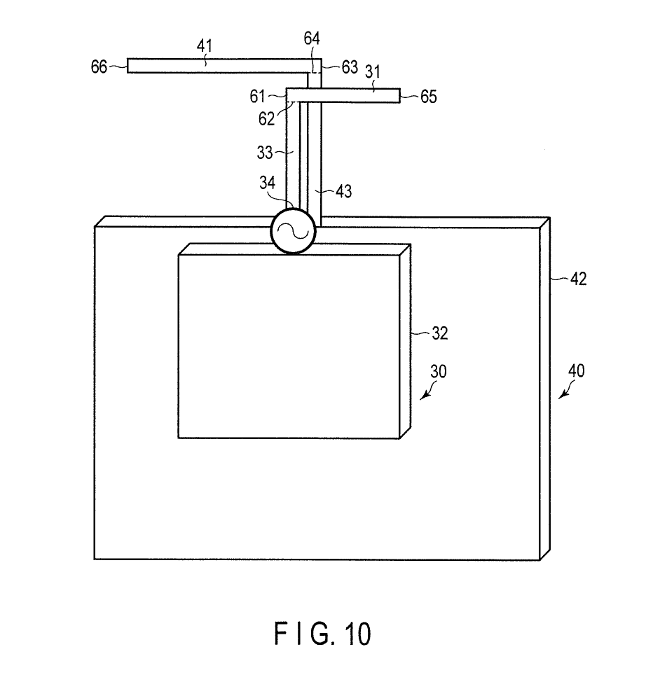

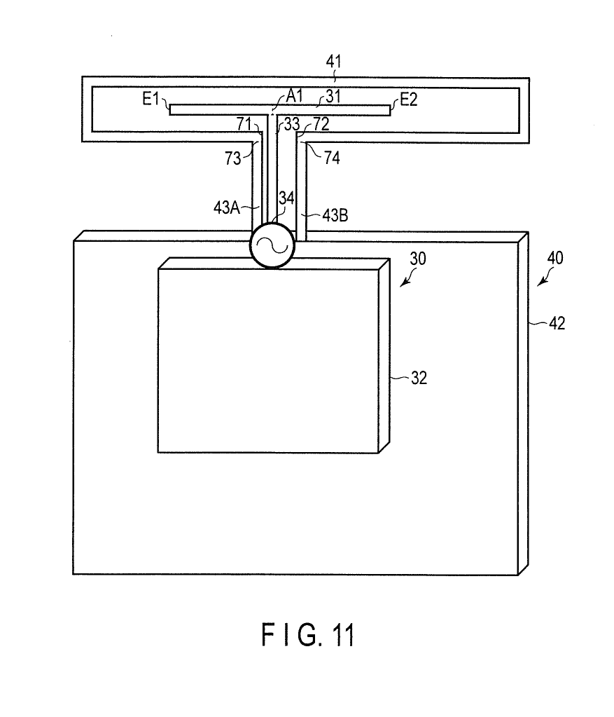

FIGS. 10 to 15 show various element arrangements that the coupler 30 and the coupler assisting element 40 may assume.

In the arrangement of FIG. 10, the power supplying element 33 of the coupler 30 and the connecting element 43 of the coupler assisting element 40 overlap each other. On the other hand, the coupling element 31 of the coupler 30 and the conductive element 41 of the coupler assisting element 40 do not overlap each other. The end 61 of the coupling element 31 and the end 62 of the power supplying element 33 are connected to each other. The coupling element 31 extends orthogonal to the power supplying element 33 and parallel to the substrate 42. The end 63 of the conductive element 41 and the end 64 of the connecting element 43 are connected to each other. The conductive element 41 extends orthogonal to the connecting element 43 and parallel to the substrate 42. The end 65 of the coupling element 31 and the end 66 of the conductive element 41 are located, clamping the power supplying element 33 and connecting element 43. Thus, the power supplying element 33 of the coupler 30 and the connecting element 43 of the coupler assisting element 40 are coupled by virtue of electromagnetic induction because the power supplying element 33 and the connecting element 43 overlap, even if the coupling element 31 and the conductive element 41 do not overlap each other.

In the arrangement of FIG. 11, the power supplying element 33 of the coupler 30 and the connecting element 43 of the coupler assisting element 40 do not overlap each other. Nor do the coupling element 31 of the coupler 30 and the conductive element 41 of the coupler assisting element 40 overlap each other.

The power supplying element 33 is connected, at one end, to the middle part A1 of the coupling element 31, at the midpoint between the first open end E1 and second open end E2 of the coupling element 31. The other end of the power supplying element 33 is connected to the feeding point 34. The middle part A1 of the coupling element 31 is exactly at, or located near, the midpoint of the coupling element 31 in the lengthwise direction thereof. The conductive element 41 is provided around the coupling element 31 of the coupler 30. The coupling element 31 has ends E1 and E2. Connecting elements 43A and 43B appear to clamp the power supplying element 33 of the coupler 30. The end 71 of the conductive element 41 is connected to one end 73 of the connecting element 43A, and the end 72 of the conductive element 41 is connected to one end 74 of the connecting element 43B. The coupling element 31 and the conductive element 41 do not overlap, but a current flows between the coupling elements 31 and 41 by virtue of electromagnetic induction since the coupling elements 31 and 41 are arranged close to each other. Although the coupling element 31 and the conductive element 43 do not overlap, the power supplying element 33 and the connecting element 43 are electromagnetically connected because the coupling element 31 and the conductive element 41 are arranged close to each other.

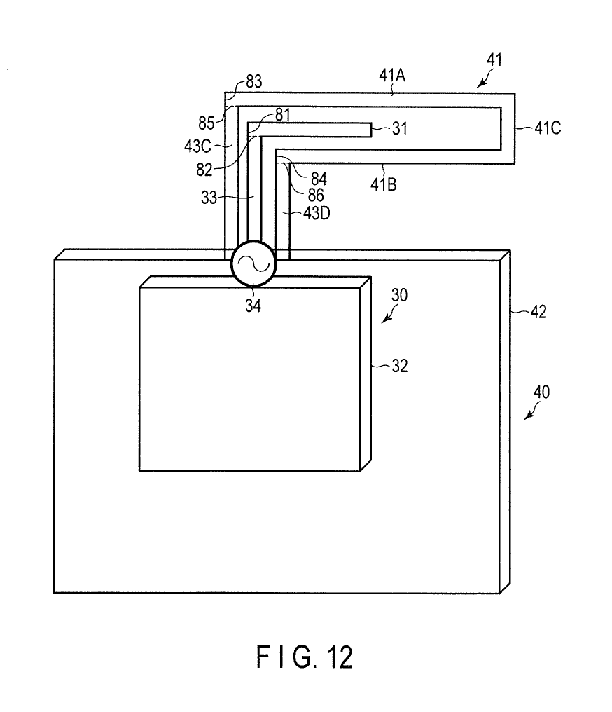

The arrangement of FIG. 12 is a modification of the arrangement shown in FIG. 11. As shown in FIG. 12, the end 81 of the coupling element 31 and the end 82 of the power supplying element 33 are connected to each other. The coupling element 31 extends orthogonal to the lengthwise direction of the power supplying element 33 and parallel to the substrate 32. The conductive element 41 is composed of elements 41A, 41B and 41C. These elements are provided around the coupling element 31 of the coupler 30. The elements 41A and 41B appear to clamp the coupling element 31. The element 41C is electrically connected to the elements 41A and 41B. The element 41A of the conductive element 41 is connected at end 83 to the end 85 of a connecting element 43C. The element 41B of the conductive element 41 is connected, at end 83, to the end 85 of a connecting element 43C. The element 41B of the conductive element 41 is connected, at end 84, to the end 86 of the connecting element 43B. The coupling element 31 and the conductive element 41 do not overlap, but are located close to each other. Therefore, the coupling element 31 and the conductive element 41 transmit and receive electromagnetic waves to and from each other, by virtue of electromagnetic induction. Although the power supplying element 33 and the coupling element 31 do not overlap, the power supplying element 33 and the connecting element 43 are electromagnetically connected because the coupling element 31 and the conductive element 41 are arranged close to each other.

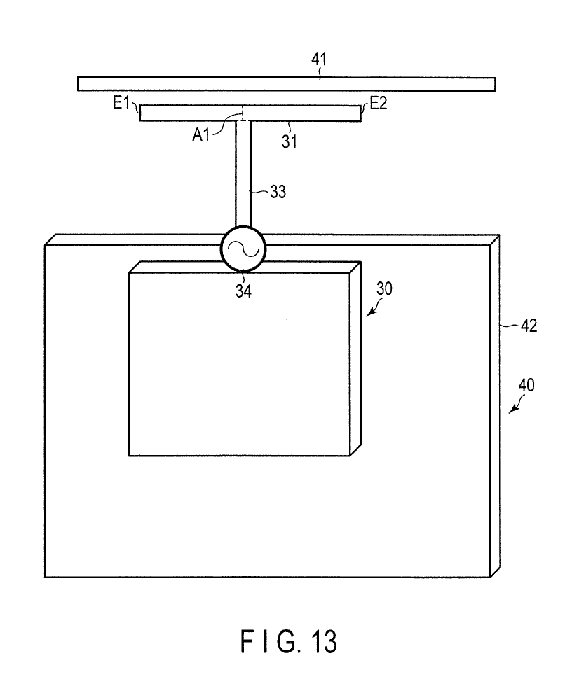

In the arrangement of FIG. 13, no elements are provided to connect the conductive element 41 and ground plane 42 to the coupler assisting element 40. The conductive element 41 of the coupler assisting element 40 overlaps the coupling element 31 of the coupler 30. No connecting elements are provided, but the conductive element 41 overlaps the coupling element 31 of the coupler 30. Therefore, the coupling element 31 and the conductive element 41 are electromagnetically coupled to each other.

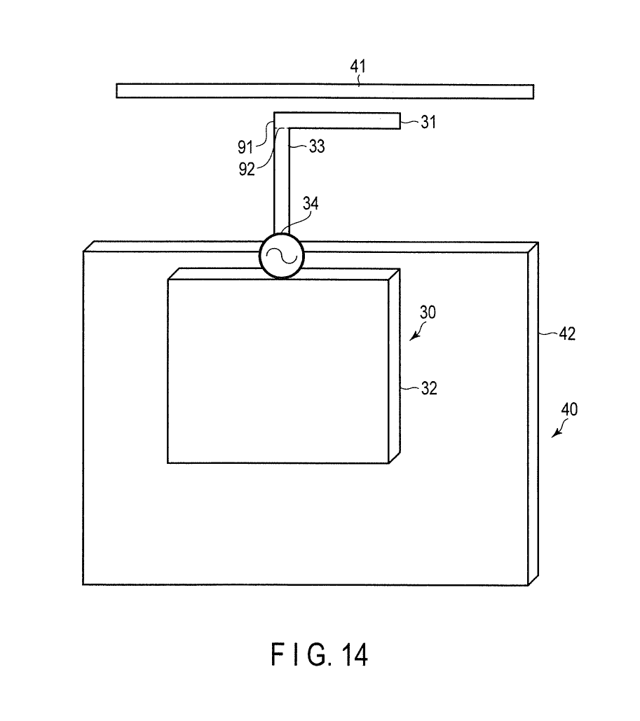

The arrangement of FIG. 14 is a modification of the arrangement shown in FIG. 13. As shown in FIG. 14, no connecting elements are provided in this arrangement, to connect the conductive element 41 and ground plane 42 to the coupler assisting element 40, as in the arrangement shown in FIG. 13. The end 91 of the coupling element 31 is connected to the end 92 of the power supplying element 33. The coupling element 31 extends orthogonal to the lengthwise direction of the power supplying element 33 and parallel to the substrate 32.

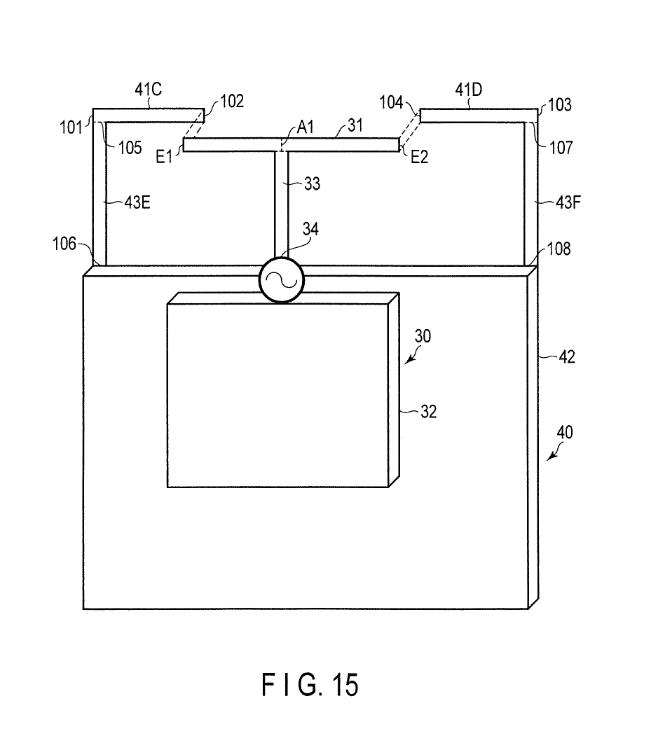

In the arrangement of FIG. 15, the power supplying element 33 of the coupler 30 and the connecting element 43 of the coupler assisting element 40 do not overlap, and the coupling element 31 of the coupler 30 and the conductive element 41 of the coupler assisting element 40 do not overlap, either.

The power supplying element 33 is connected, at one end, to the middle part A1 of the coupling element 31, at the midpoint between the first open end E1 and second open end E2 of the coupling element 31. The other end of the power supplying element 33 is connected to the feeding point 34. The middle part A1 of the coupling element 31 is exactly at, or located near, the midpoint of the coupling element 31 in the lengthwise direction thereof.

Conductive elements 41C and 41D are arranged to clamp the coupling element 31. One end 102 of the conductive element 41C is located near the first end E1 of the coupling element 31. One end 104 of the conductive element 41D is located near the second end E2 of the coupling element 31. The conductive elements 41C and 41D may in part overlap the coupling element 31, or may not overlap the power supplying element 33 at all. The other end 101 of the conductive element 41C is connected to one end 105 of a connecting element 43E. The other end 106 of the connecting element 43E is connected to the ground plane 42. The other end 103 of the conductive element 41D is connected to one end 107 of a connecting element 43F. The other end 108 of the connecting element 43F is connected to the ground plane 42.

The end 102 of the conductive element 41C is close to the first end E1 of the coupling element 31, and the end 104 of the conductive element 41D is located near the second end E2 of the coupling element 31. Therefore, the conductive element 41C and the coupling element 31 are electromagnetically coupled, and so are the conductive element 41D and the coupling element 31.

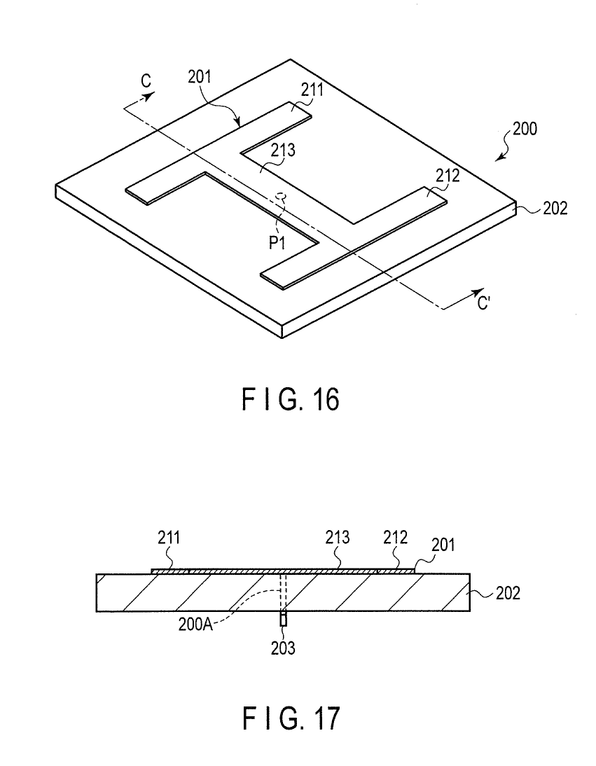

A coupler 200 having a three-dimensional structure, according to the embodiment, will be described with reference to FIG. 16 and FIG. 17. FIG. 16 is a perspective view showing this coupler 200, and FIG. 17 is a sectional view of this coupler 200, taken along line C-C′ shown in FIG. 16. The coupler 200 may be incorporated in, for example, the card device 20 or an electronic apparatus having no card slots.

As shown in FIG. 16 and FIG. 17, the coupler 200 includes a coupling element 201 and a substrate 202. The coupling element 201 and the substrate 202 are shaped like a flat plate.

The substrate 202 is a base member including a dielectric element. Hereinafter, the substrate 202 will be called a “dielectric substrate.” The coupling element 201 is provided, for example, on the surface of the dielectric substrate 202. The coupling element 201 is an electrode (coupling electrode) that is shaped like a flat plate. The coupling element 201 is arranged on the surface of the dielectric substrate 202.

As shown in FIG. 17, a power supplying terminal 203 extends through the dielectric substrate 202 and is connected to the feeding point P1 of the coupling element 201. The power supplying terminal 203 functions as a connector for a power supplying cable (for example, coaxial cable). A signal is supplied to the feeding point P1 of the coupling element 201 through the power supplying cable and the power supplying terminal 203 provided in a first through hole 200A made in the dielectric substrate 202.

The shape of the coupling element 201 will be described. The coupling element 201 is shaped like a flat plate. As shown in FIG. 16, the coupling element 201 is composed of one coupling element 213 and two elements (rectangular elements) 211 and 212. The rectangular elements 211 and 212 are spaced apart and extend parallel to each other. The coupling element 213 connects the middle parts of the rectangular elements 211 and 212. In other words, the coupling element 201 is shaped like the letter H. The feeding point P1 is exactly at, or located near, the midpoint of the coupling element 201 (i.e., center of the coupling element 201).

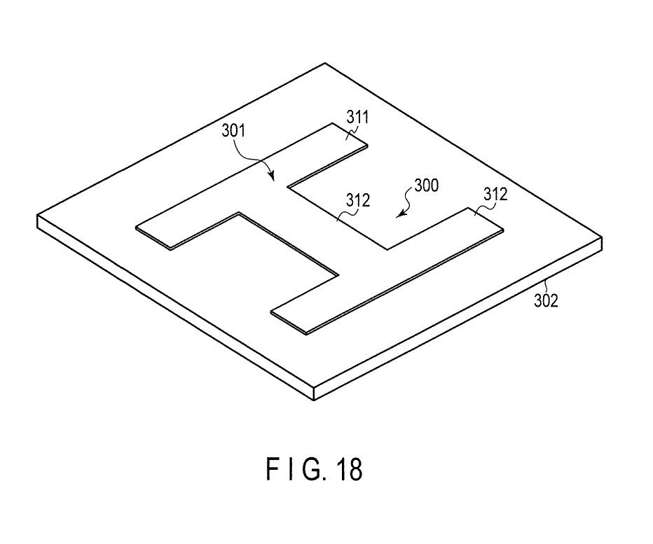

FIG. 18 is a diagram showing a coupler assisting element 300 associated with the coupler 200 according to the embodiment. The coupler assisting element 300 is provided in the electronic apparatus having the coupler 200 or in an electronic apparatus having a card slot which may hold the card device having the coupler 200. If the electronic apparatus is a smart phone, the card slot is exposed while the rear cover remains removed from the smart phone. The coupler assisting element 300 may be provided on that side of the battery cover 302, which is at the back of the smart phone. Note that the coupler 200 may be provided at the battery loaded in the smart phone or on the substrate provided in the smart phone.

As shown in FIG. 18, the coupler assisting element 300 has a non-coupling element 301. The non-coupling element 301 is shaped like a flat plate, in a plane perpendicular to its widthwise direction. The non-coupling element 301 is composed of one coupling element 313 and two elements (rectangular elements) 311 and 312. The rectangular elements 311 and 312 are spaced apart and extend parallel to each other. The coupling element 313 connects the middle parts of the rectangular elements 311 and 312. In other words, the non-coupling element 301 is shaped like the letter H.

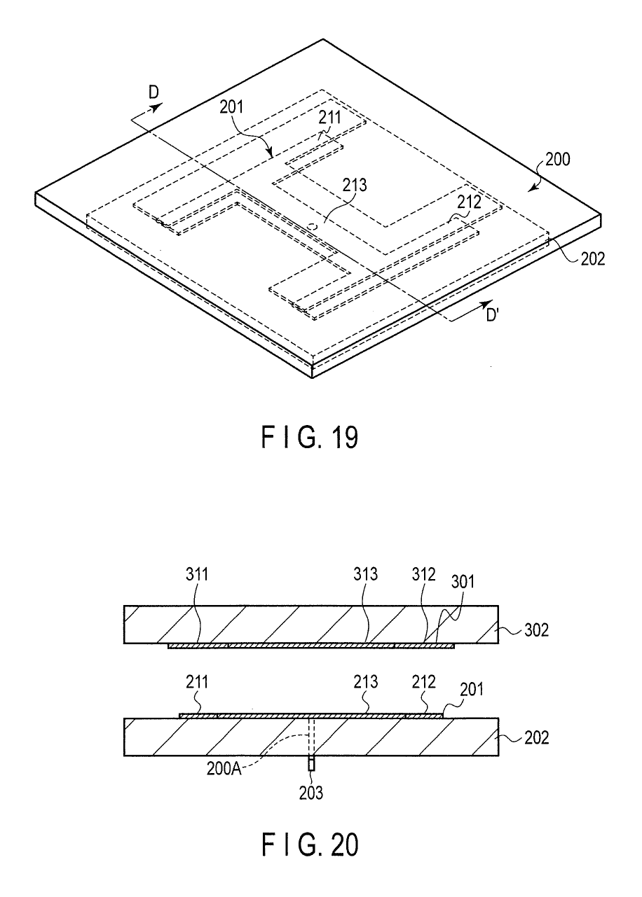

FIG. 19 and FIG. 20 are diagrams showing the positional relation the coupler 200 and the coupler assisting element 300 have while the card device incorporating the coupler 200 remains inserted in the card slot of an electronic apparatus. FIG. 19 is a perspective view showing the coupler 200 and the coupler assisting element 300, and FIG. 20 is a sectional view of the coupler 200 and coupler assisting element 300, taken along line D-D′ shown in FIG. 19.

As shown in FIG. 19 and FIG. 20, the coupling element 201 and the non-coupling element 301 are located close to each other, overlapping each other. The element 211 of the coupler 200 and the element 311 of the coupler assisting element 300 are located close to each other, overlapping each other. Similarly, the element 212 of the coupler 200 and the element 312 of the coupler assisting element 300 are located close to each other, overlapping each other. Further, the coupling element 213 of the coupler 200 and the coupling element 313 of the coupler assisting element 300 are located close to each other, overlapping each other.

Since the non-coupling element 301 of the coupler assisting element 300 overlaps the coupling element 201 of the coupler 200, they are electromagnetically coupled to each other.

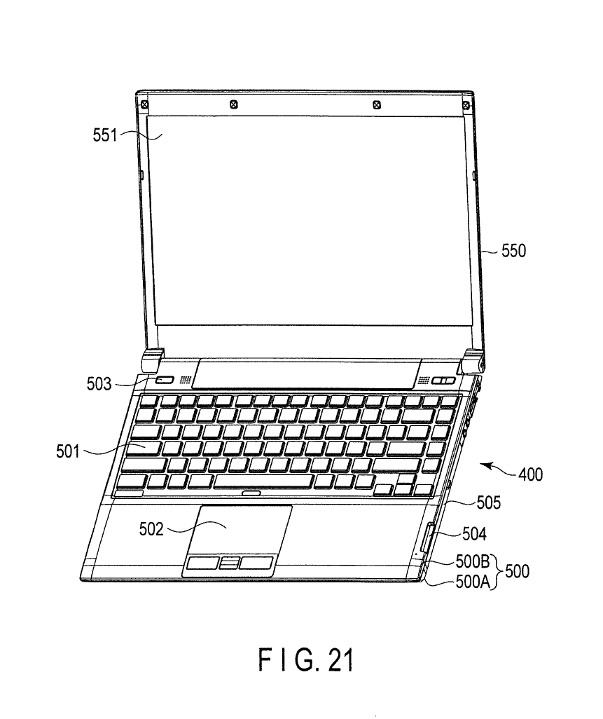

FIG. 21 is a perspective view showing an electronic apparatus having a card slot into which the card device 20 may be inserted. The electronic apparatus is a data processing apparatus, such as a notebook-type portable personal computer 400 that can be driven by batteries.

The computer 400 comprises a main unit 500 and a display unit 550. The display unit 550 is secured to the main unit 500. The display unit 550 can be rotated with respect to the main unit 500, between an open position and a closed position. In the open position, the display unit 550 exposes the upper surface of the main unit 500. In the closed position, it covers the upper surface of the main unit 500. The housing of the display unit 550 holds a liquid crystal display (LCD) 551.

The main unit 500 has a housing shaped like a thin box. The housing of the main unit 500 is composed of a lower case 500A and an upper case 500B, which are fitted together. On the upper surface of the main unit 500, a keyboard 501, a touch panel 502 and a power switch 503 are arranged. A card slot 504 is made in, for example, the right side of the housing of the main unit 500. As shown in FIG. 21, the card slot 504 is located above an optical disk drive 505 incorporated in the housing of the main unit 500.

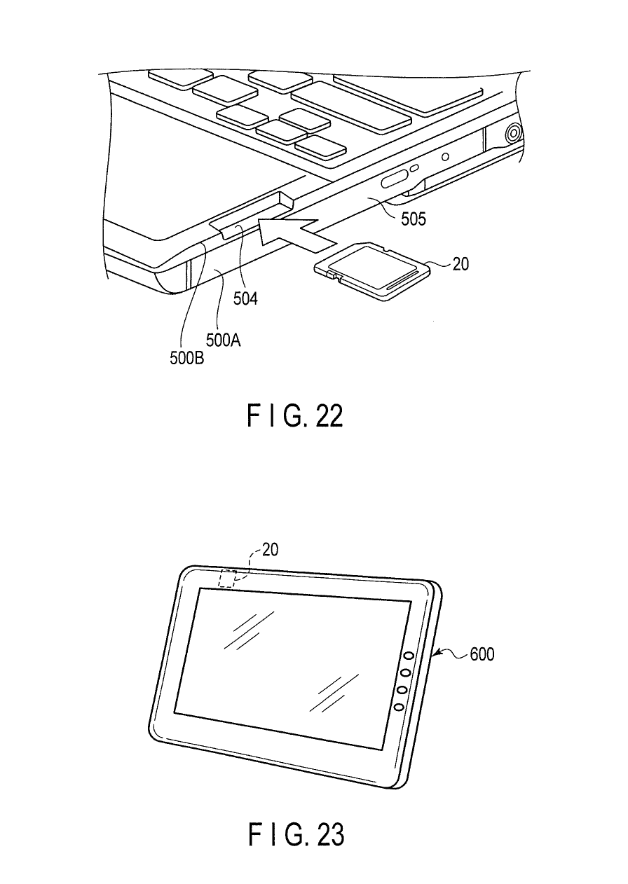

FIG. 22 is a magnified perspective view of that part of the main unit 500, which has the card slot 504. As shown in FIG. 22, a card device 20 may be removably inserted into the card slot 504.

The electronic apparatus into which the card device 20 is inserted is not limited to the portable personal computer 400. FIG. 23 shows a slate PC 600 into which a card device 20 has been inserted.

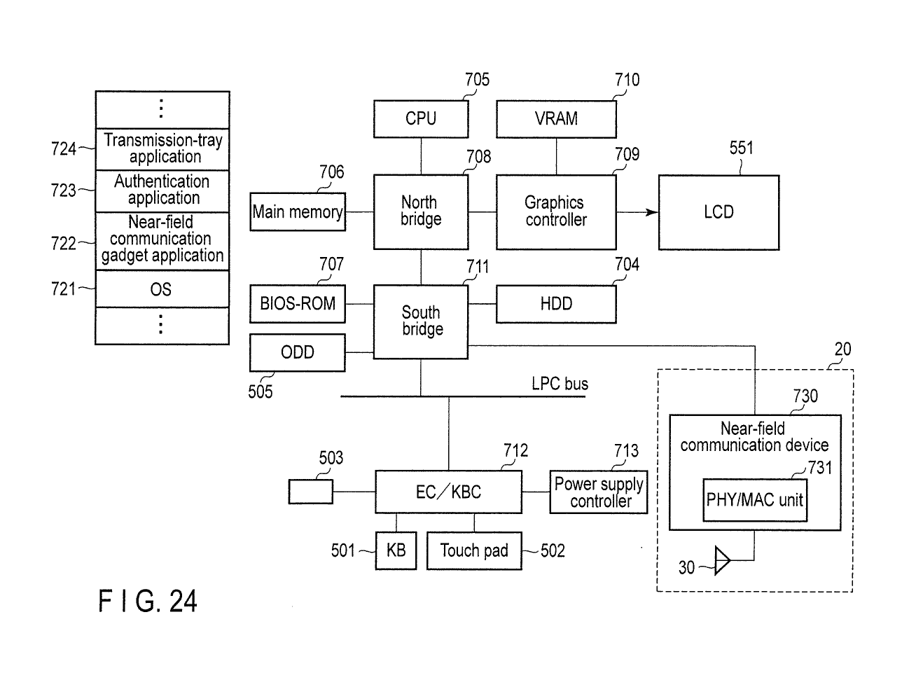

FIG. 24 is a block diagram showing the system configuration of the computer 400.

In addition to the keyboard 501, touch panel 502, power switch 503, optical disk drive (ODD) 505 and LCD 551, the computer 400 includes a hard disk drive (HDD) 704, a CPU 705, a main memory 706, a basic input/output system (BIOS)-ROM 707, a north bridge 708, a graphics controller 709, a video memory (VRAM) 710, a south bridge 711, an embedded controller/keyboard control IC (EC/KBC) 712, and a power supply controller 713.

The hard disk drive 704 stores the operating system (OS) 721 and various application programs. The CPU 705 is a processor that controls the other components of the computer 400, and executes the various programs loaded from the hard disk drive 704 into the main memory 706. The programs the CPU 705 executes including the operating system 721, near-field communication gadget application program 722, authentication application program 723 and out-box application program 724. The CPU 705 executes also the BIOS program stored in the BIOS-ROM 707.

The north bridge 708 connects the local bus of the CPU 705 and the south bridge 711, and built in a memory controller configured to perform an access control on the main memory 706. The north bridge 708 has the function of achieving communication with the graphics controller 709 through, for example, an AGP bus. The graphics controller 709 controls the LCD 551, and generates video signals from the video data stored in the video memory 710. The video signals so generated represent images the LCD 551 may display. The video data has been written in the video memory 710 under the control of the CPU 705.

The south bridge 711 controls the devices provided on an LPC bus, and has an ATA controller configured to control the hard disk drive 704. The south bridge 711 further has the function of performing an access control on the BIOS-ROM 707. The embedded controller/keyboard control IC (EC/KBC) 712 is a one-chip microcomputer built in an embedded controller and a keyboard controller. The embedded controller controls the power supply controller 713 as the user operates the power switch 503. When so controlled, the power supply controller 713 turns on or off the computer 400. The keyboard controller controls the keyboard 501 and the touch panel 502. The power supply controller 713 controls a power supply device (not shown). The power supply device generates operating power for the components of the computer 400.

Data is transferred between the south bridge 711 and the near-field communication device 730 built in the card device 20, through, for example, a peripheral component interconnect (PCI) bus. Instead of the PCI bus, a PCI Express bus may be used.

The near-field communication device 730 incorporated in the card device 20 is a communication module designed to achieve near field communication. The near-field communication device 730 comprises a PHY/MAC unit 731. The PHY/MAC unit 731 operates under the control of the CPU 705, transmitting and receiving signals by radio through the coupler 30.

Note that the computer 400 is exemplified as an electronic apparatus into which the card device having the coupler 30 is inserted. Nonetheless, the electronic apparatus may be, for example, a TV receiver. Further, the card device 20 incorporating the coupler 30 or a card incorporating both the coupler 30 and the near-field communication device 730 may be inserted into the slots of the electronic apparatus.

To suppress the characteristic degradation of the coupler 30 incorporated in the micro SD card 20, the coupler assisting element 40 is provided in the electronic apparatus. Alternatively, the coupler assisting element 40 may be provided in a conversion adaptor to be inserted into the card slot, to convert the micro SD card to an SD card.

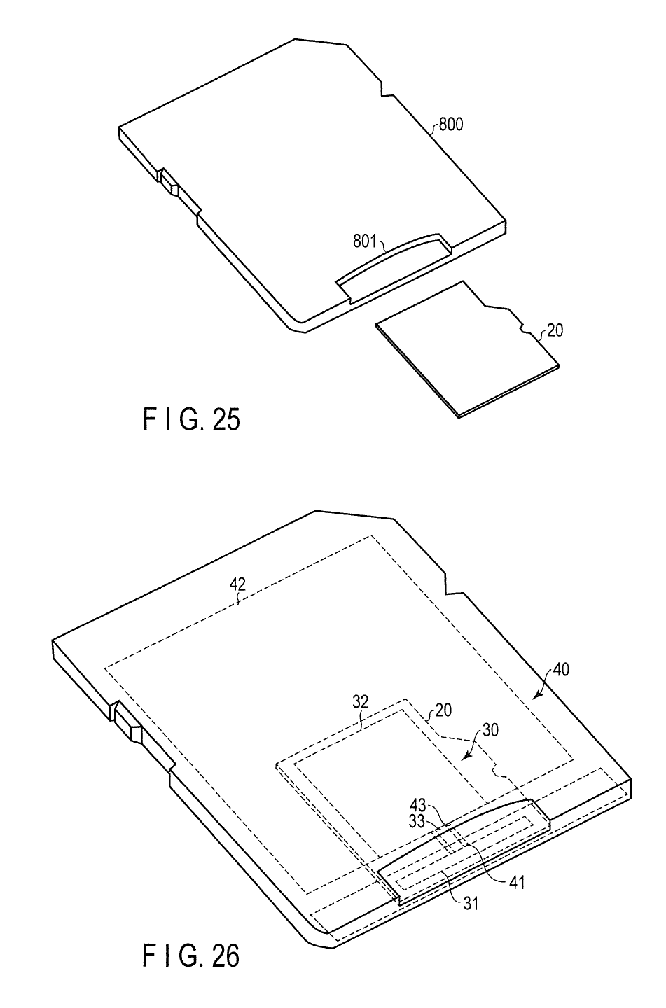

FIG. 25 is a perspective view showing the conversion adaptor. As FIG. 25 shows, the conversion adaptor 800 has a card slot 801, into which the micro SD card (i.e., attachable device) 20 may be inserted.

FIG. 26 is a perspective view showing the micro SD card 20 inserted in the conversion adaptor 800. As shown in FIG. 26, the connecting element 43 provided in the conversion adaptor 800 overlaps the power supplying element 33 provided in the micro SD card 20, and the conductive element 41 provided in the conversion adaptor 800 overlaps the coupling element 31 provided in the conversion adaptor 800.

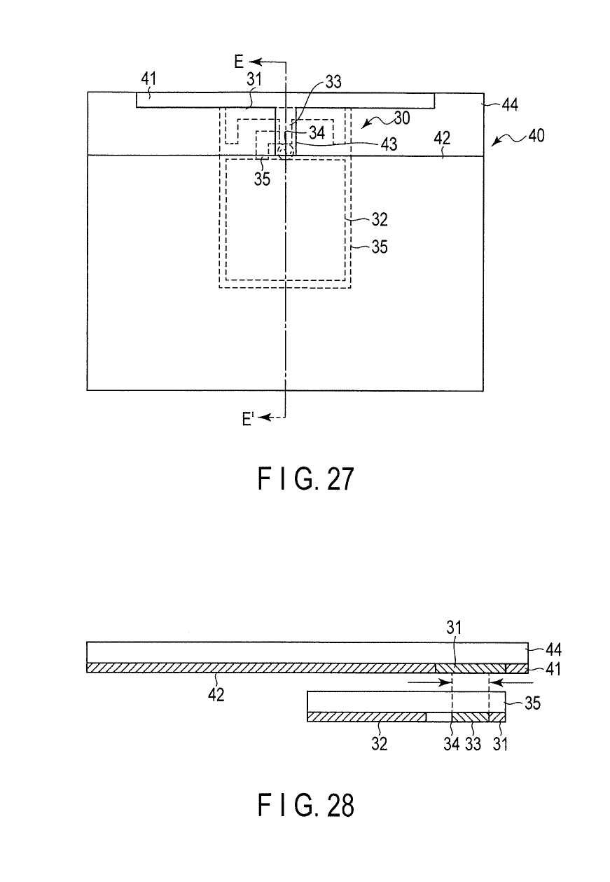

FIG. 27 and FIG. 28 are diagrams showing the positional relation the card device has with the coupler assisting element while it remains inserted in the card slot of the electronic apparatus. More precisely, FIG. 27 is a plan view showing the positional relation the coupler and coupler assisting element have while the card device remains inserted in the card slot of the electronic apparatus. FIG. 28 is a sectional view showing the coupler and the coupler assisting element, taken along line E-E′ shown in FIG. 27.

As shown in FIG. 27 and FIG. 28, the conductive element 41 of the coupler assisting element 40 does not overlap the coupling element 31 of the coupler 30. By contrast, the connecting element 43 of the coupler assisting element 40 overlaps the power supplying element 33 of the coupler 30. Since the connecting element 43 and the power supplying element 33 overlap each other, they are electromagnetically coupled together by virtue of electromagnetic induction.

The positional relation of the coupler and coupler assisting element, which is shown in FIG. 10 to FIG. 15, may be applied to the electronic apparatus shown in FIG. 4 or to the conversion adaptor shown in FIG. 26. Further, the positional relation of the coupler and coupler assisting element, which is shown in FIG. 4, may be applied to the conversion adaptor shown in FIG. 26. Conversely, the positional relation shown in FIG. 26 may be applied to the electronic apparatus of FIG. 4.

In the embodiment, the coupler is arranged in the card device such as an SD card, and the card device may be inserted into the electronic apparatus or the conversion adaptor. Further, the non-coupling element having no feeding points is provided in the housing of the electronic apparatus or in the conversion adaptor. The non-coupling element is located near the coupling element connected to the feeding point. The coupler therefore achieves a better communication performance than in the case it is not arranged in the card device.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising a attachment for removably inserted a attachable device configured to transmit and receive electromagnetic waves,
the attachable device comprising a union element, and a power supplying element provided on a first surface and connecting the union element to a feeding point; and
the electronic apparatus comprising a non-union element,
wherein at least part of the non-union element or at least part of a conductive member projecting from the non-union element faces the power supplying element and is spaced apart from the power supplying element when the attachable device is inserted in the attachment.

2. The apparatus of claim 1, wherein the attachable device comprises a coupler configured to transmit and receive electromagnetic waves by a electromagnetic coupling with another coupler.

3. The apparatus of claim 1, further comprising a first ground plane,
wherein the power supplying element is provided on the first surface, the conductive member is provided on a second surface facing away from the first surface and spaced apart from the first surface, and connects the non-union element and the first ground plane.

4. The apparatus of claim 1, wherein the conductive member projects from a middle part of longitudinal direction of the non-union element.

5. The apparatus of claim 1, wherein the attachable device further comprises a second ground plane and a second short-circuiting element connecting the power supplying element and the second ground plane, and the first ground plane and the second ground plane are electrically connected.

6. An electronic apparatus comprising:
a first element configured to transmit and receive electromagnetic waves and comprising a union element and a power supplying element provided on a first surface, the power supplying element connecting the union element and a feeding point; and
a non-union element,
wherein at least part of the non-union element or at least part of a conductive member projecting from the non-union element faces the power supplying element and is spaced apart from the power supplying element.

7. The apparatus of claim 6, wherein the first element is a coupler configured to transmit and receive electromagnetic waves by electromagnetic coupling with another coupler.

8. The apparatus of claim 6, further comprising a first ground plane,
wherein the power supplying element is provided on the first surface, and the conductive member is provided on a second surface facing away from the first surface and spaced apart from the first surface, and connects the non-union element and the first ground plane.

9. The apparatus of claim 6, wherein the conductive member projects from a middle part of longitudinal direction of the non-union element.

10. The apparatus of claim 6, further comprising a second ground plane and a second short-circuiting element connecting the power supplying element and the second ground plane,
wherein the first ground plane and the second ground plane are electrically connected.

11. The apparatus of claim 6, wherein the first element is provided in a attachable device, and the attachable device is inserted into a attachment provided in the apparatus.

12. A conversion adaptor comprising a first attachment into which a attachable device is removably inserted and being inserted into a second attachment provided in an electronic apparatus, the attachable device configured to transmit and receive electromagnetic waves,
the attachable device comprising a union element, and a power supplying element provided on a first surface and connecting the union element and a feeding point, and
the conversion adaptor comprising a non-union element,
wherein at least part of the non-union element or at least part of a conductive member projecting from the non-union element faces the power supplying element and is spaced apart from the power supplying element when the attachable device is inserted into the first attachment.

13. The adaptor of claim 12, wherein the attachable device comprises coupler configured to transmit and receive electromagnetic waves by electromagnetic coupling with another coupler.

14. The adaptor of claim 12, further comprising a first ground plane,
wherein the power supplying element is provided on a first surface, and the conductive member is provided on a second surface facing away from the first surface and spaced apart from the first surface, and is configured to connect the non-union element and the first ground plane.

15. The adaptor of claim 12, wherein the conductive member projects from a middle part of longitudinal direction of the non-union element.

16. The adaptor of claim 12, wherein the attachable device comprises a second ground plane and a second short-circuiting element connecting the power supplying element and the second ground plane, and the first ground plane and the second ground plane are electrically connected.
